(19) United States
(12) Patent Application Publication
(10) Pub. No.: US 2015/0257362 A1
(43) Pub. Date: Sep. 17, 2015

(54) Chew Deterrent Protective Dog Collar and Method

(71) Applicant: Kyle Smith, Leesburg, GA (US)

(72) Inventor: Kyle Smith, Leesburg, GA (US)

(21) Appl. No.: 14/214,937

(22) Filed: Mar. 15, 2014

(51) Int. Cl. A01K 13/00

(52) U.S. Cl. CPC A01K 13/006

(57) ABSTRACT

The current invention is a chew and destruction deterrent protective collar and a method for the impregnation of plastics and other materials and use of those impregnated materials for other household items

### CROSS-REFERENCE TO RELATED APPLICATIONS

Provisional Application No. 61/801,103 Confirmation #4583

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISK APPENDIX

Not applicable

### BACKGROUND OF THE INVENTION

The present invention is in the technical field of protective dog collars. More particularly, the present invention is in the technical field of protective dog collars that can be used to prevent contact between the animal's head and other parts of the body. Protective collars are particularly useful for preventing additional injury post-surgery.

Protective collars, which are typically shaped as inverse cones or wide strips that go around an animal's neck to prevent the animal from scratching or reaching other parts of their body are used post-surgery in order to keep the animal from reaggravating the wounds or surgery dressings.

A majority of the conventional, protective collars are made with a hard or soft plastic depending on the manufacture of the collar. Either way, these collars are often not wanted by the animal, so the animal precedes to scratching, clawing and biting at the collar itself. Very often the animal, typically a dog that is prone to chewing will succeed in damaging the protective collar. In the process the collar may become damaged in a way that may render it not only useless but perhaps even hazardous due to sharp edges and the collars capacity to cause choking of the animal.

Dog chew deterrents are well known and readily available in the current market, and include heat sprays, bitter sprays, etc., along with many common natural deterrents such as vinegar, hot sauce, bitters, etc. These deterrents are typically rubbed or sprayed on to surfaces or objects where chewing is undesired. What typically happens is that the animal will first test or try the object that has been treated with the deterrent and upon receiving the undesirable taste or effect, the animal will form a learned response to stay away from those treated objects. The issue with these sprays and rubs is that they are sprays and rubs and will inherently rub off of the desired object onto other objects and contaminate items that the person did not want treated with the deterrent. The sprays and rubs, for the most part, do not seem to have a very long staying power and may constantly need to be reapplied.

### SUMMARY AND DESCRIPTION OF THE INVENTION

The present invention is a protective animal collar in the same general shapes as those collars that are presently known and commonly found that has been impregnated with a chew deterrent that will give an improved protection with a life span significantly longer than those collars currently available and known. The general idea is that this device by being impregnated with a chew deterrent would significantly decrease the animals desire to destroy what was placed on them with the idea of protecting them and would improve the user friendliness of the device because no other step would be necessary to discourage this behavior. Impregnation of a material is known art in the current market, with the primary goal of taking a material and making it structurally a part of another material by binding the materials together, or more specifically by locking of the impregnated material within the matrix of the host material during manufacture.

The impregnated deterrent can be any number of potentially discouraging compounds, anything that would be undesirable to animals to a point of discouraging the animal from messing with the protective collar. In one embodiment, the protective device which may be in the form of a cone or simply wide neck strap, which may be made out of a multitude of materials including polyethylenes, poly vinyl chloride and other plastics and polymers, the protective collar would be impregnated with a capsaicin or synthetic capsaicin (nonivamide). Capsaicin is the source of the ‘heat’ that is tasted in peppers, and when a pepper has a higher capsaicin level it is generally considered ‘hotter’. Capsaicin is also used in pepper spray deterrents, so it seems that it would be highly effective as an impregnated chew deterrent. In another embodiment, the protective collar may be impregnated with a natural herbal deterrent. In yet another embodiment, the impregnated materials used for the discouragement of chewing could be used in other products that the pet or animal comes into contact with on a regular basis such as kennels, leashes, shoe soles, seat covers, seat belt clasp covers, and remote controls, etc.

The current invention could also be seen as a method to prevent the seemingly uncontrollable chewing tendencies of some animals. The impregnation of collars and other items that the animal comes into contact with will become less desirable than items without the impregnation, however the dog will come to associate that all products with a texture or look similar to those items which are impregnated may also be repulsive and the animals chew tendencies may regress for all household items.

In the prior descriptions of the preferred embodiments, reference are made as the construction and intent of this invention, which form a part hereof, and within which are shown by way of description specific embodiments by which the invention may be practiced. It is understood that other embodiments may be utilized and structural changes may be made without departing from the scope of the invention.

In broad embodiment, the present invention is a chew and destruction deterrent protective collar. This device will allow the protective collar to serve its' purpose of preventing the animal from either reaggravating the prior injury or from causing another injury. Impregnated plastic devices commonly found may also be utilized to help change the animal's destructive behavior. Further still, the device will be universal and designed to fit a wide variety of animals so the additional cost of having to have multiple shapes and sizes on hand will be minimized.

### BRIEF DESCRIPTION OF THE DRAWINGS

FIG. 1 is a front view of one embodiment of a protective animal collar.

FIG. 2 is a cutaway view of one embodiment of an impregnated material.

### DETAILED DESCRIPTION OF THE DRAWINGS

In the following detailed description of the preferred embodiments, reference is made to the accompanying drawings which form a part hereof, and within which are shown by way of illustration specific embodiments by which the invention may be practiced. It is understood that other embodiments may be utilized and structural changes may be made without departing from the scope of the invention.

Turning now to the drawings wherein like numbers refer to like features throughout the drawings, the present invention comprises a chew deterrent protective dog collar and method.

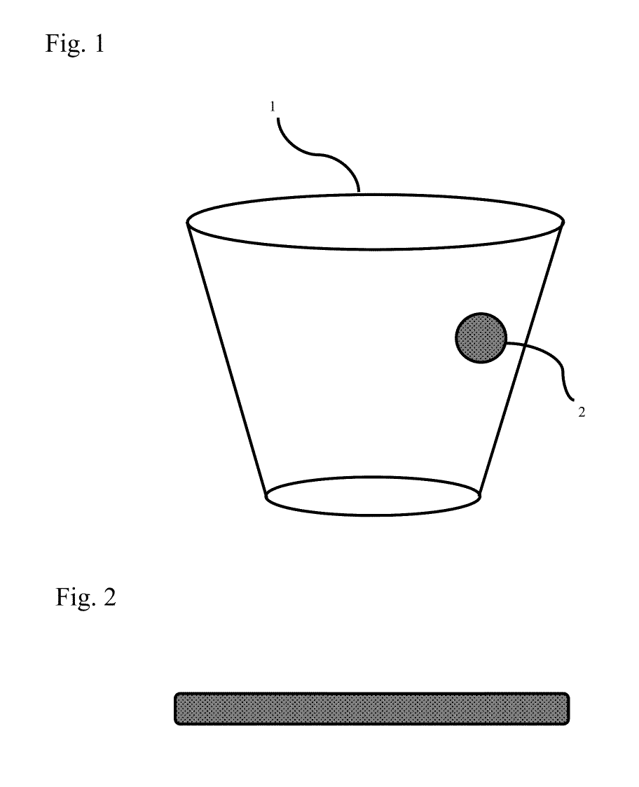

Referring now to the invention in more detail, in FIG. 1 there is shown a front view of a commonly known shape and construction of a protective collar 1 typically used post-surgery to prevent the animal from accessing and aggravating the surgical wound or other areas. An animal's head would go into the small end of this collar 1. This illustration also shows the highly magnified and exaggerated view of deterrent compounds impregnated in the material 2. Although in this preferred embodiment of the current invention the collar is shown to be in the form of a truncated cone, in another embodiment the current invention can be in the form of an inflatable pillow. In another embodiment of the current invention the collar can be in the form of a cylinder.

Referring now to the invention shown in FIG. 2 there is shown a highly magnified and exploded view of how the impregnated chemicals and/or compounds shall be evenly dispersed throughout the material.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiments, methods, and examples, but by all embodiments and methods within the scope and spirit of the invention.

What is claimed:

1. A protective collar for an animal in the same general shapes and sizes as those collars that are presently known and commonly found that has been impregnated with a chew deterrent chemical or compound.

2. The collar in claim 1, wherein the collar is intended for a dog.

3. The collar in claim 1, wherein the collar is intended for a cat.

4. The collar in claim 1, wherein the collar takes the shape of a truncated cone.

5. The collar in claim 1, wherein the collar takes a tubular shape.

6. The collar in claim 1, wherein the collar is made of an inflatable bladder.

7. The collar in claim 1, wherein the collar is made of some form of plastic sheet.

8. The collar in claim 1, wherein the collar consists of some basic wrap around the animal's neck.

9. The collar in claim 1, wherein the collar is impregnated with capsaicin or synthetic capsaicin.

10. The collar in claim 1, wherein the collar is impregnated with any number of herbal deterrents.

11. A method of impregnating protective animal and/or post-surgical animal collars with a chew deterrent chemical or compound so that the deterrent is evenly spread within the material that the collar is made of and has great longevity.

12. A method of impregnating materials and using the impregnated materials for the manufacture of other products that the pet or animal comes into contact with on a regular basis such as kennels, leashes, shoe soles, seat covers, seat belt clasp covers, and remote controls, etc.
